(19) United States
(12) Patent Application Publication
(10) Pub. No.: US 2025/0335721 A1
(43) Pub. Date: Oct. 30, 2025

(54) METHOD AND SYSTEM FOR EXTENDING CONTEXT WINDOW

(71) Applicant: SAMSUNG SDS CO., LTD., Seoul (KR)

(72) Inventors: Sung Min LEE, Seoul (KR); Seungki HONG, Seoul (KR)

(73) Assignee: SAMSUNG SDS CO., LTD., Seoul (KR)

(21) Appl. No.: 19/080,348

(22) Filed: Mar. 14, 2025

(30) Foreign Application Priority Data
Apr. 29, 2024 (KR) 10-2024-0056423
Sep. 2, 2024 (KR) 10-2024-0118290

(51) Int. Cl. G06F 40/40

(52) U.S. Cl. CPC G06F 40/40

(57) ABSTRACT

There is provided a method for extending a context window. The method may comprise: performing a rotary position embedding computation on a first embedding vector and a second embedding vector input to an artificial intelligence model to calculate a first position embedding and a second position embedding respectively corresponding to the first embedding vector and the second embedding vector; calculating a self-attention score between the first embedding vector and the second embedding vector, based on the first position embedding and the second position embedding; performing position interpolation on the self-attention score in order to extend a context window of the artificial intelligence model; calculating a decay weight related to a relative position difference between the first embedding vector and the second embedding vector; and applying the calculated decay weight to the self-attention score subjected to the position interpolation, thereby updating the self-attention score.

### CROSS-REFERENCE TO RELATED APPLICATIONS

This application claims priority from Korean Patent Application No. 10-2024-0056423 filed on Apr. 29, 2024 and No. 10-2024-0118290 filed on Sep. 2, 2024 in the Korean Intellectual Property Office, and all the benefits accruing therefrom under 35 U.S.C. 119, the contents of which in its entirety are herein incorporated by reference.

### BACKGROUND

### Field

The present disclosure relates to a method and system for extending a context window, and more particularly, to a method for extending a context window using a rotary position encoding (RoPE) to which a decay weight has been applied in a large language model (LLM).

### Description of Related Art

A trained large language model (LLM) is typically provided together with a predefined context window length. Most of large language models perform well on a task with a limited context window length, but do not perform well on a request having a context window length larger than the limited context window length. For example, a large language model has a limitation in that it does not provide inherent performance on a task requiring a larger context window length in a learning process, such as performing a long conversation and summarizing a long document such as a research paper. This is because a large language model is trained according to a limited context window length, and thus a distribution of a position of a token that has not been previously learned on the longer context window occurs.

In order to solve this problem, a scheme of fine-tuning the trained language model using a longer context window has been used. However, in the fine tuning process, learning about a new context position distribution may be unstably performed, or a side effect of deteriorating the inherent performance of the large language model may occur. Alternatively, in order to extend the length of the context window, a position interpolation scheme in which a position index of the token is reduced to be adapted to a size of the original window may be used. The position interpolation scheme is a method of reducing the position index so that the maximum position index complies with the limitation of the context window in the pre-training step.

In order to indicate an input order of consecutive tokens in a large language model, position information is generally injected into the token via a position encoding process. Among the position encoding schemes, rotary position embedding (RoPE) refers to a scheme of encoding absolute positions of tokens using a rotation matrix and deriving relative distance information between the tokens in a self-attention process. Since a self-attention score in a large language model based on the rotary position embedding is represented as a sum of trigonometric functions having various frequencies, an amplitude change according to the relative position between the tokens is large.

In particular, when the position interpolation scheme is used, as the relative position difference between the tokens increases, a range of the self-attention score decreases accordingly, resulting in a problem in that the precision of the relative position information is lowered. This causes instability in the training in the process of fine-tuning the model. Therefore, there is a need for a method capable of solving a problem in which an amount of relative position information decreases due to position interpolation for extension of the context window in the large language model based on the rotary position embedding.

### SUMMARY

A technical purpose to be achieved through embodiments of the present disclosure is to provide a method of reducing instability of a self-attention score based on a relative position difference between embedding vectors while extending a context window using a rotary position encoding (RoPE) to which a decay weight has been applied in a large language model (LLM).

In addition, a technical purpose to be achieved through embodiments of the present disclosure is to provide a method of reducing a range in which a self-attention score between embedding vectors decreases and reducing an amplitude of a change in the self-attention score based on a relative position difference between embedding vectors when extending a context window of a large language model (LLM) using rotary position embedding (RoPE)-based position interpolation, and processing a prompt having a large length in fine tuning of the model.

The technical purposes of the present disclosure are not limited to the technical purposes mentioned above, and other technical purposes not mentioned may be clearly understood by those skilled in the art from the following description.

A method for extending a context window according to one embodiment of the present disclosure may be performed by a computing device, and may comprise: performing a rotary position embedding computation on a first embedding vector and a second embedding vector input to an artificial intelligence model to calculate a first position embedding and a second position embedding respectively corresponding to the first embedding vector and the second embedding vector; calculating a self-attention score between the first embedding vector and the second embedding vector, based on the first position embedding and the second position embedding; performing position interpolation on the self-attention score in order to extend a context window of the artificial intelligence model; calculating a decay weight related to a relative position difference between the first embedding vector and the second embedding vector; and applying the calculated decay weight to the self-attention score subjected to the position interpolation, thereby updating the self-attention score.

In one embodiment, the performing of the position interpolation may include: determining, as a scaling factor, a ratio of a second length of a context window as an extension target length to a first length of a context window initially preset on the artificial intelligence model; and scaling the relative position difference by the scaling factor.

In one embodiment, the performing of the position interpolation may include: obtaining a rotation matrix corresponding to the self-attention score; and scaling a rotation angle of the rotation matrix by a preset scaling factor.

In one embodiment, the decay weight may be exponentially decreased as the relative position difference increases.

In one embodiment, a hyperparameter of the decay weight may be determined such that a first amplitude of the self-attention score based on the relative position difference after the decay weight has been applied is reduced relative to a second amplitude of the self-attention score based on the relative position difference before the decay weight is applied by a preset target ratio.

In one embodiment, the preset target ratio may be determined based on at least one of a length of a prompt input to the artificial intelligence model, a length of a context window preset on the artificial intelligence model, a length of a context window as an extension target length on the artificial intelligence model, a performance of the artificial intelligence model, and a purpose of a task performed by the artificial intelligence model.

In one embodiment, the method may further comprise fine-tuning the artificial intelligence model using the updated self-attention score.

In one embodiment, the first embedding vector may be a query vector, and the second embedding vector may be a key vector.

A computing device according to another embodiment of the present disclosure may comprise: a processor; and a memory for storing therein instructions, wherein when the instructions are executed by the processor, the instructions may cause the processor to: perform a rotary position embedding computation on a first embedding vector and a second embedding vector input to an artificial intelligence model to calculate a first position embedding and a second position embedding respectively corresponding to the first embedding vector and the second embedding vector; calculate a self-attention score between the first embedding vector and the second embedding vector, based on the first position embedding and the second position embedding; perform position interpolation on the self-attention score in order to extend a context window of the artificial intelligence model; calculate a decay weight related to a relative position difference between the first embedding vector and the second embedding vector; and apply the calculated decay weight to the self-attention score subjected to the position interpolation, thereby updating the self-attention score.

In one embodiment, the performing of the position interpolation may include: determining, as a scaling factor, a ratio of a second length of a context window as an extension target length to a first length of a context window initially preset on the artificial intelligence model; and scaling the relative position difference by the scaling factor.

In one embodiment, the performing of the position interpolation may include: obtaining a rotation matrix corresponding to the self-attention score; and scaling a rotation angle of the rotation matrix by a preset scaling factor.

In one embodiment, the decay weight may be exponentially decreased as the relative position difference increases.

In one embodiment, wherein a hyperparameter of the decay weight may be determined such that a first amplitude of the self-attention score based on the relative position difference after the decay weight has been applied is reduced relative to a second amplitude of the self-attention score based on the relative position difference before the decay weight is applied by a preset target ratio.

In one embodiment, wherein the preset target ratio may be determined based on at least one of a length of a prompt input to the artificial intelligence model, a length of a context window preset on the artificial intelligence model, a length of a context window as an extension target length on the artificial intelligence model, a performance of the artificial intelligence model, and a purpose of a task performed by the artificial intelligence model.

In one embodiment, when the instructions are executed by the processor, the instructions may further cause the processor to fine-tune the artificial intelligence model using the updated self-attention score.

A non-transitory computer-readable recording medium storing computer program, wherein the computer program is connected to a computing device, and is configured to, when executed by the computing device, cause the computing device to: perform a rotary position embedding computation on a first embedding vector and a second embedding vector input to an artificial intelligence model to calculate a first position embedding and a second position embedding respectively corresponding to the first embedding vector and the second embedding vector; calculate a self-attention score between the first embedding vector and the second embedding vector, based on the first position embedding and the second position embedding; perform position interpolation on the self-attention score in order to extend a context window of the artificial intelligence model; calculate a decay weight related to a relative position difference between the first embedding vector and the second embedding vector; and apply the calculated decay weight to the self-attention score subjected to the position interpolation, thereby updating the self-attention score.

In one embodiment, the performing of the position interpolation may include: determining, as a scaling factor, a ratio of a second length of a context window as an extension target length to a first length of a context window initially preset on the artificial intelligence model; and scaling the relative position difference by the scaling factor.

In one embodiment, the performing of the position interpolation may include: obtaining a rotation matrix corresponding to the self-attention score; and scaling a rotation angle of the rotation matrix by a preset scaling factor.

In one embodiment, the decay weight may be exponentially decreased as the relative position difference increases.

In one embodiment, a hyperparameter of the decay weight may be determined such that a first amplitude of the self-attention score based on the relative position difference after the decay weight has been applied is reduced relative to a second amplitude of the self-attention score based on the relative position difference before the decay weight is applied by a preset target ratio.

Specific details of other embodiments are included in the detailed description and drawings.

### BRIEF DESCRIPTION OF DRAWINGS

The above and other aspects and features of the present disclosure will become more apparent by describing in detail embodiments thereof with reference to the attached drawings, in which:

FIG. 1 is a block diagram illustrating an example configuration of an entire system according to an embodiment of the disclosure;

FIG. 2 is a flowchart illustrating a context window extension method according to an embodiment of the present disclosure;

FIG. 3 illustrates an embodiment of a step of performing position interpolation of FIG. 2;

FIG. 4 illustrates another embodiment of the step of performing the position interpolation of FIG. 2;

FIG. 5 illustrates a result of position interpolation for context window extension according to an embodiment of the present disclosure;

FIG. 6 illustrates a result of position interpolation for context window extension according to another embodiment of the present disclosure;

FIG. 7 illustrates an example of a decay weight according to an embodiment of the disclosure; and

FIG. 8 is a block diagram illustrating a hardware configuration of a computing device including an artificial intelligence model according to an embodiment of the disclosure.

### DETAILED DESCRIPTION

Preferred embodiments of the present disclosure will hereinafter be described in detail with reference to the accompanying drawings. The advantages, features, and methods of achieving them of the present disclosure will become clearer with the embodiments described in detail along with the accompanying drawings. However, the present disclosure is not limited to the embodiments described below and can be implemented in various different forms. These embodiments are provided only to make the disclosure complete and fully inform those of ordinary skill in the technical field to which the present disclosure belongs, and the present disclosure is defined only by the scope of the claims.

It is noted that the same reference numerals are used for the same elements across different drawings as far as possible. Furthermore, in describing the present disclosure, detailed descriptions of known configurations or functions will be omitted when they may obscure the essence of the present disclosure.

Unless defined otherwise, all terms used herein (including technical and scientific terms) can have the meaning commonly understood by one of ordinary skill in the art to which the present disclosure belongs. Terms defined in commonly used dictionaries are not interpreted in an ideal or excessive manner unless explicitly defined otherwise. The terms used in the present specification are for the purpose of describing particular embodiments only and are not intended to limit the invention. In this specification, the singular forms include plural forms unless the context clearly indicates otherwise.

Furthermore, in describing the components of the present disclosure, terms such as first, second, A, B, (a), (b), etc., may be used. These terms are intended to distinguish the components from others, and the essence, order, or sequence of such components is not limited by these terms. If a component is stated as being “connected,” “coupled,” or “linked” to another component, the component can be directly connected or linked to the other component, but it should be understood that there may also exist other components “connected,” “coupled,” or “linked between them.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

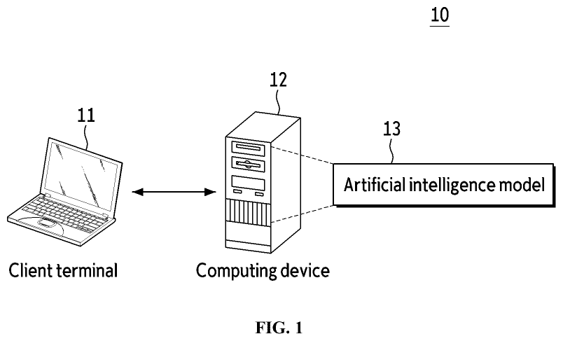

FIG. 1 is a block diagram illustrating an example configuration of an entire system 10 according to an embodiment of the present disclosure. Referring to FIG. 1, the entire system 10 may include a client terminal 11 and a computing device 12. In addition, the computing device 12 according to an embodiment of the disclosure may include an artificial intelligence model 13.

For reference, the artificial intelligence model 13 of the present disclosure refers to a neural network model having a universal understanding ability of a language (or natural language/text) by learning a vast amount of texts (e.g., texts of various domains). Since the artificial intelligence model 13 of the present disclosure may refer to a large model having query and response capabilities based on a text interface, or may refer to a model capable of ‘generating’ a response to a query, and thus may be named as a ‘large language model (LLM)’, a ‘generative AI model’, a ‘query-response model’, an ‘interactive model’, or the like in some cases. Hereinafter, in the present disclosure, ‘artificial intelligence model’ and ‘large language model’ may be used interchangeably with each other, and the artificial intelligence model 13 may be implemented as a transformer based on an attention method.

The client terminal 11 is a terminal used by a user which communicates with the computing device 12 and perform a specific task using the artificial intelligence model 13. For example, the user may input a prompt for performing a specific task to the artificial intelligence model 13 of the computing device 12 through the client terminal 100. In addition, the artificial intelligence model 13 may perform a specific task indicated by the prompt to output a response. For example, the client terminal 11 may include a smart phone, a tablet PC, a laptop, and the like. However, the present disclosure is not limited thereto, and the client terminal 11 may include all kinds of computing devices including a computation means and a communication means.

The computing device 12 may execute the artificial intelligence model 13 in response to a request (prompt) of the user of the client terminal 11. The artificial intelligence model 13 may convert an input token constituting the prompt into an embedding vector, and may inject position information into the embedding vector to calculate a corresponding position embedding. In addition, when a length of the prompt exceeds a preset length of a context window, the artificial intelligence model 13 according to an embodiment of the disclosure may extend the context window via position interpolation. In this regard, the artificial intelligence model 13 may apply a preset decay weight thereto to minimize a loss of information involved in the context window extension.

Hereinafter, embodiments in which the artificial intelligence model 13 calculates position embeddings corresponding to two embedding vectors, respectively, and extends the context window of the artificial intelligence model 13 based on the calculated position embeddings and a decay weight will be reviewed. For convenience of description, the two embedding vectors will be referred to as a first embedding vector and a second embedding vector, respectively. The first embedding vector and the second embedding vector may correspond to respective results of embedding two different input tokens included in a prompt input from a user. For example, the first embedding vector may correspond to a query vector of the large language model, and the second embedding vector may correspond to a key vector of the large language model.

The artificial intelligence model 13 may perform a rotary position embedding (RoPE) computation on the first embedding vector and the second embedding vector to calculate corresponding first position embedding and second position embedding. Regarding the embedding vector x=[x₀, x₁, x_{d-1}]^{T}, when the position index indicating the relative position of each embedding vector is m, a rotary position embedding function f(x, m) may be defined as Equation 1 as set forth below.

$$f ( x , m ) = {[ ( {x}_{0} + {ix}_{1} ) {e}^{im {θ}_{0}} , ( {x}_{2} + {ix}_{3} ) {e}^{im {θ}_{1}} , ... , ( {x}_{d - 2} + {ix}_{d - 1} ) {e}^{im {θ}_{d / 2 - 1}} ]}^{T} \qquad [ Equation 1 ]$$

where d refers to a dimension of an attention head included in a transformer structure of the artificial intelligence model 13, i=\sqrt{−1} and θ={θⱼ|θⱼ=10000^{-2j/d}, d∈{0,1, . . . , d/2−1}}.

The artificial intelligence (AI) model 13 may calculate a self-attention score between the first embedding vector and the second embedding vector based on the first position embedding and the second position embedding calculated via the rotary position embedding computation. For example, the self-attention score a(m, n) between the first embedding vector (e.g., the query vector) q and the second embedding vector (e.g., the key vector) k in the transformer structure may be calculated based on the first position embedding f(q, m) and the second position embedding f(k, n) as in Equation 2 as set forth below. In this regard, m and n are position indices indicating relative positions of the first embedding vector and the second embedding vector, respectively.

$$\begin{matrix}a ( m , n ) = Re < f ( q , m ) , f ( k , n ) > \\ = Re [ {\sum }_{j = 0}^{d / 2 - 1} ( {q}_{2 j} + {iq}_{2 j + 1} ) ( {k}_{2 j} - {ik}_{2 j + 1} ) {e}^{i ( m - n ) {θ}_{j}} ] \\ = {\sum }_{j = 0}^{d / 2 - 1} [ ( {q}_{2 j} {k}_{2 j} + {q}_{2 j + 1} {k}_{2 j + 1} ) cos ( ( m - n ) {θ}_{j} ) + \\ ( {q}_{2 j} {k}_{2 j + 1} - {q}_{2 j + 1} {k}_{2 j} ) sin ( ( m - n ) {θ}_{j} ) ] \\ = g ( q , k , θ , m - n )\end{matrix} \qquad [ Equation 2 ]$$

That is, the self-attention score calculated based on the rotary position embedding scheme may be expressed as a sum of trigonometric functions having various frequencies, and depends on a rotation angle θ of a rotation matrix represented by a sum of the trigonometric functions and a relative position difference m-n between the tokens.

In one example, in order to clearly grasp the distribution of the self-attention score based on the relative position difference between the tokens, the self-attention score calculated based on the above Equation 2 is approximated so that only a cosine function portion thereof remains as in Equation 3 as set forth below in following descriptions.

$$g ( q , k , θ , m - n ) \approx {\sum }_{j = 0}^{d / 2 - 1} cos ( ( m - n ) {θ}_{j} ) \qquad [ Equation 3 ]$$

When the extension of the context window is required, the artificial intelligence model 13 may perform position interpolation on the self-attention score. In some embodiments, the position interpolation may be performed in a manner of scaling the relative position difference m-n between the tokens. In some further embodiments, the position interpolation may be performed in a manner of scaling the rotation angle θ of the rotation matrix.

First, a linear interpolation scheme of scaling the relative position difference m-n will be described. When a length of the context window preset on the artificial intelligence model 13 is L₁ and a length of the context window as an extension target length is L₂, a scaling factor α on the relative position difference m-n may be determined as L₂/L₁. Accordingly, according to the linear interpolation scheme, the self-attention score may be calculated as

$$g ( q , k , θ , \frac{m - n}{α} ) .$$

In this case, the larger the length L₂ of the context window as an extension target length, the larger α value will be used for the scaling.

Second, an adjusted base frequency (ABF) scheme of scaling the rotation angle θ will be described. After the rotation matrix has been determined via the rotary position embedding computation, the artificial intelligence model 13 may scale the rotation angle θj=10000^{((-2j)/d)} by a scaling factor β into θⱼ′=(β·10000)^{((-2j)/d)}. Accordingly, according to the ABF scheme, the self-attention score may be calculated as g(q, k, θⱼ′, m-n). Like the linear interpolation scheme, the larger the length of the context window as an extension target length, the larger β value will be used for scaling.

Via the above-described position interpolation scheme, even when the length of the prompt exceeds the preset length of the context window, the response of the artificial intelligence model 13 may be output using the extended context window. However, when performing the position interpolation in the linear interpolation scheme or the ABF scheme, as the relative position difference between the tokens increases, the precision of the unique information according to the position of each token is lowered. In this regard, the lowered precision of the unique information means that a self-attention score difference between the token corresponding to the position index m and the token corresponding to the position index n is reduced.

In order to minimize this problem, the context window extension method according to an embodiment of the present disclosure may apply a preset decay weight to the position interpolation result of the self-attention score calculated according to the rotary position embedding computation. Hereinafter, embodiments of calculating and applying the decay weight will be reviewed.

The artificial intelligence model 13 may calculate a decay weight related to the relative position difference (i.e., m-n) between the first embedding vector and the second embedding vector. The decay weight may be defined as a reduction function on a relative position difference between embedding vectors (i.e., a relative position difference between tokens). Accordingly, as the decay weight increases, a size and an amplitude of the self-attention score may be simultaneously reduced. For example, the decay weight W may be defined as an exponential function that decreases based on the relative position difference as shown in Equation 4 as set forth below.

$$W ( m - n , γ ) = exp ( - \frac{m - n}{γ} ) \qquad [ Equation 4 ]$$

where γ is a hyperparameter that may be determined based on the length of the context window as an extension target length, and may be defined to have a larger value as the length to be extended increases.

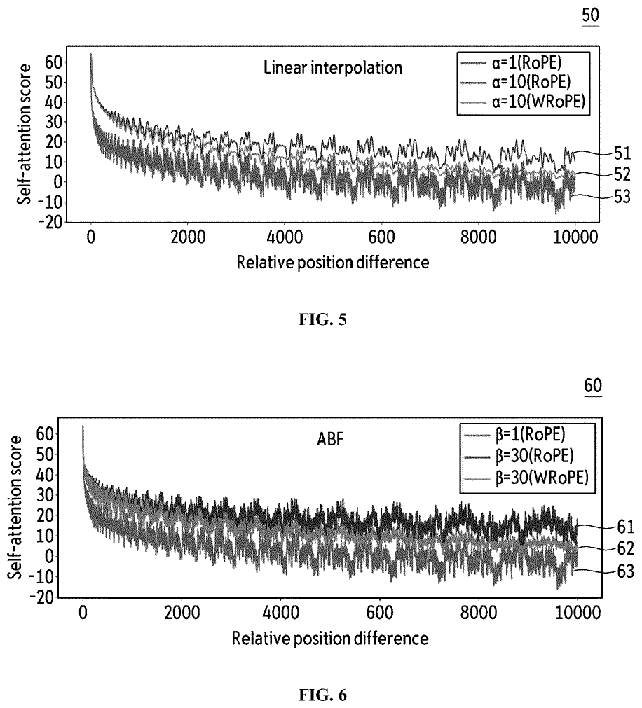

The artificial intelligence model 13 may apply the decay weight calculated as described above to the self-attention score on which the position interpolation has been performed to update the self-attention score. When the self-attention score obtained by performing the position interpolation on the existing self-attention score g(q, k, θ, m-n) in either the linear interpolation scheme or the ABF scheme is g′, the self-attention score updated by applying the decay weight thereto may be expressed as W·g′. Applying the decay weight thereto may allow the change in the self-attention score as the relative position difference m-n value between tokens increases to be smaller. The effect of applying the decay weight will be described later with reference to FIGS. 5 to 7. The artificial intelligence model 13 may be further fine-tuned using the updated self-attention score.

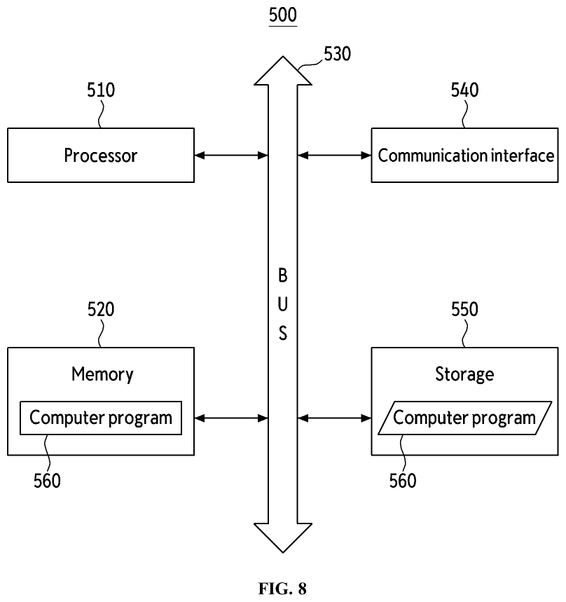

The computing device 12 may be configured using one or more physical servers included in a server farm based on cloud technology such as a virtual machine. A detailed configuration and operation of the computing device 12 according to an embodiment of the present disclosure will be described later with reference to FIG. 8.

The components illustrated in FIG. 1 may communicate over a network. For example, the network may be implemented as any kind of wired/wireless network such as a Local Area Network (LAN), a Wide Area Network (WAN), a mobile radio communication network, a wireless broadband Internet (Wibro), etc.

Hereinafter, embodiments related to the context window extension of the artificial intelligence model 13 will be reviewed.

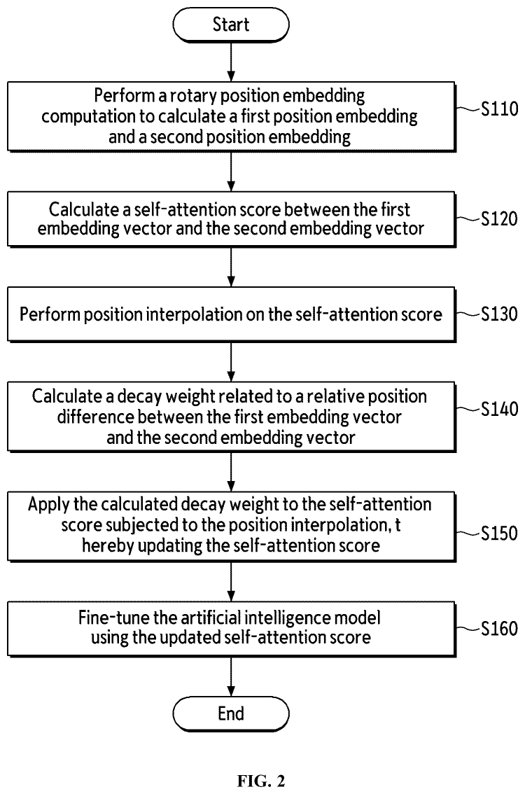

FIG. 2 is a flowchart illustrating a context window extension method according to an embodiment of the present disclosure. For reference, FIG. 2 and FIGS. 3 to 4, which will be described later, show steps/operations performed in the computing device 12 of FIG. 1 or the computing device 500 of FIG. 8. Accordingly, in the following descriptions, it may be understood that when a subject of a specific step/operation is omitted, the step/operation is performed in the computing device 12 of FIG. 1 or the computing device 500 of FIG. 8.

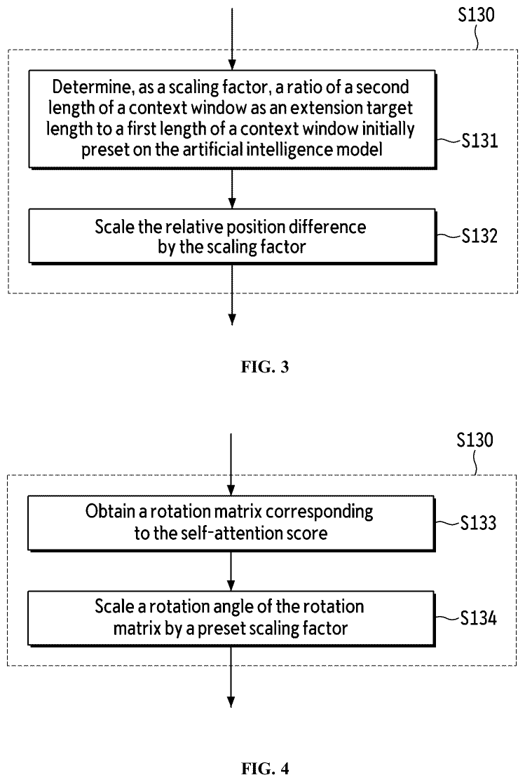

In operation S110, a rotary position embedding (RoPE)) computation may be performed on the first embedding vector and the second embedding vector to calculate a first position embedding and a second position embedding respectively corresponding to the first embedding vector and the second embedding vector. For example, the rotary position embedding computation may be performed with reference to Equation 1 described above. Thereafter, in operation S120, a self-attention score between the first embedding vector and the second embedding vector may be calculated. For example, the calculation of the self-attention score may be performed with reference to Equations 2 and 3 described above. Next, in operation S130, the position interpolation may be performed on the self-attention score for extension of the context window. Hereinafter, embodiments related to the position interpolation will be reviewed with reference to FIGS. 3 to 4.

FIG. 3 illustrates an embodiment of the operation S130 of performing the position interpolation of FIG. 2. Referring to FIG. 3, in operation S131, a ratio of a second length of a context window as an extension target length to a first length of a context window that is initially preset may be determined as a scaling factor. In operation S132, a relative position difference between the first embedding vector and the second embedding vector may be scaled by the scaling factor determined in the operation S131. The embodiment of FIG. 3 may correspond to the linear interpolation scheme among the position interpolation schemes.

FIG. 4 illustrates another embodiment of the operation S130 of performing the position interpolation of FIG. 2. Referring to FIG. 4, in operation S133, a rotation matrix corresponding to a self-attention score between a first embedding vector and a second embedding vector may be obtained. In operation S134, the rotation angle of the rotation matrix obtained in the operation S133 may be scaled by a preset scaling factor. The embodiment of FIG. 4 may correspond to the ABF scheme among the position interpolation schemes.

Returning again to FIG. 2, in operation S140, the decay weight related to the relative position difference between the first embedding vector and the second embedding vector may be calculated. For example, the decay weight may be calculated in a form of a function (e.g., an exponential function) that decreases as the relative position difference increases. In operation S150, the self-attention score may be updated by applying the decay weight thereto. Thereafter, in operation S160, the artificial intelligence model may be fine-tuned using the updated self-attention score.

Hereinafter, with reference to FIGS. 5 to 6, the position interpolation for the context window extension and an effect of the application of the decay weight will be reviewed.

FIG. 5 illustrates a result of position interpolation for context window extension according to an embodiment of the present disclosure. Referring to a graph 50 of FIG. 5, a scaling factor α, a relative position difference (m-n) between embedding vectors (between tokens), and a distribution of the self-attention score regarding the linear interpolation scheme are shown. Reference numeral 53 indicates a case where the scaling factor α=1 (that is, a case where the position interpolation is not performed), reference numeral 51 indicates a case where α=10, and reference numeral 52 indicates a case where the decay weight is applied and α=10.

When the position interpolation is not performed as shown in reference numeral 53, the self-attention score converges to 0 when the relative position difference increases beyond the preset length of the context window. Further, when the position interpolation is performed as shown in reference numeral 51, the self-attention score does not converge to 0, while the amplitude based on the relative position difference increases, and there is a problem that the difference in the self-attention score based on the relative position difference is not clear. When the decay weight is applied as shown in reference numeral 52, the self-attention score does not converge to 0, and the amplitude decreases, such that the difference of the self-attention score based on the relative position difference becomes clearer.

FIG. 6 illustrates a result of position interpolation for context window extension according to another embodiment of the present disclosure. Referring to a graph 60 of FIG. 6, a scaling factor β, a relative position difference (m-n) between embedding vectors (between tokens), and a distribution of the self-attention score regarding the ABF scheme are shown. Reference numeral 63 indicates a case where the scaling factor β=1 (that is, a case where the position interpolation is not performed), reference numeral 61 indicates a case where the scaling factor β=30, and the reference numeral 62 indicates a case where the decay weight is applied and is β=30. As described with reference to FIG. 5, when the decay weight is applied as shown in reference numeral 62, the amplitude is reduced while the self-attention score does not converge to 0, and thus the difference of the self-attention score based on the relative position difference becomes clearer.

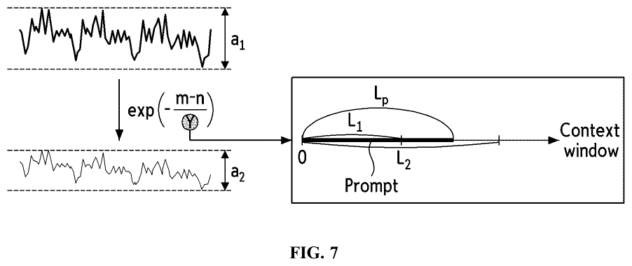

FIG. 7 illustrates an example of a decay weight according to an embodiment of the disclosure. Referring to FIG. 7, the amplitude a₁ of the self-attention score based on the relative position difference before the decay weight is applied and the amplitude a₂ of the self-attention score based on the relative position difference after the decay weight is applied are shown. For example, the hyperparameter γ of the decay weight may be determined such that the amplitude a₂ after the decay weight is applied is reduced relative to the amplitude a₁ before the decay weight is applied by a preset target ratio (i.e., a₂/a₁ is equal to the preset target ratio).

The target ratio may be determined based on a length Lₚ of a prompt input to the artificial intelligence model, a length L₁ of a context window preset on the artificial intelligence model, a length L₂ of a context window as an extension target length, a performance of the artificial intelligence model, and a purpose of a task requested by the user through the prompt.

FIG. 8 is a block diagram illustrating a hardware configuration of a computing device 500 including an artificial intelligence model according to an embodiment of the disclosure.

Referring to FIG. 8, the computing device 500 may include one or more processors 510, a bus 530, a communication interface 540, a memory 520 for loading a computer program executed by the processor 510 therein, and storage 550 for storing therein the computer program 560. However, FIG. 8 shows only components related to an embodiment of the present disclosure. Accordingly, a person skilled in the art to which the present disclosure belongs may appreciate that the computing device 500 may further include other general-purpose components in addition to the components shown in FIG. 8. That is, various components may be further included in the computing device 500 in addition to the components illustrated in FIG. 8. Further, in some cases, the computing device 500 may be configured in a form in which some of the components illustrated in FIG. 8 are omitted. Hereinafter, each of the components of the computing device 500 will be described.

The processor 510 may control an operation of each of the components of the computing device 500. The processor 510 may include at least one of a central processing unit (CPU), a micro processor unit (MPU), a micro controller unit (MCU), a graphic processing unit (GPU), or any type of processor well known in the technical field of the present disclosure. In addition, the processor 510 may perform a computation on at least one application or program for executing an operation/method according to embodiments of the present disclosure. The computing device 500 may include one or more processors.

Next, the memory 520 may store various data, commands and/or information therein. The memory 520 may load therein the computer program 560 from the storage 550 to execute an operation/method according to embodiments of the present disclosure. The memory 520 may be embodied as a volatile memory such as RAM. However, the present disclosure is not limited thereto.

Next, the bus 530 may provide a communication function between the components of the computing device 500. The bus 530 may be embodied as various types of buses such as an address bus, a data bus, and a control bus.

Next, the communication interface 540 may support wired/wireless Internet communication of the computing device 500. Further, the communication interface 540 may support various communication schemes other than Internet communication. To this end, the communication interface 540 may be configured to include a communication module well known in the technical field of the present disclosure.

Next, the storage 550 may non-temporarily store therein one or more computer programs 560. The storage 550 may include a non-volatile memory, such as a read only memory (ROM), an erasable programmable ROM (EPROM), an electrically erasable programmable ROM (EEPROM), a flash memory, a hard disk, a removable disk, or any type of computer-readable recording medium well known in the art to which the present disclosure pertains.

Next, the computer program 560 may include one or more instructions that cause the processor 510 to perform an operation/method according to various embodiments of the disclosure when being loaded into the memory 520. That is, the processor 510 may perform an operation/method according to various embodiments of the disclosure by executing one or more loaded instructions.

For example, the computer program 560 may include instructions for performing a rotary position embedding computation on a first embedding vector and a second embedding vector input to an artificial intelligence model to calculate a first position embedding and a second position embedding respectively corresponding to the first embedding vector and the second embedding vector; calculating a self-attention score between the first embedding vector and the second embedding vector, based on the first position embedding and the second position embedding; performing position interpolation on the self-attention score in order to extend a context window of the artificial intelligence model; calculating a decay weight related to a relative position difference between the first embedding vector and the second embedding vector; and applying the calculated decay weight to the self-attention score subjected to the position interpolation, thereby updating the self-attention score.

According to an embodiment of the disclosure, instability of the self-attention score based on the relative position difference between the tokens may be reduced via the large language model (LLM) based on the weighted rotary position encoding (RoPE). In particular, according to an embodiment of the present disclosure, when the position interpolation scheme is applied to extend the context window of the large language model based on the rotary position embedding, a range in which the self-attention score is decreased may be reduced, and the amplitude change of the self-attention score based on the relative position difference between the tokens may be reduced, so that the large language model may be stably trained in a fine tuning process. Furthermore, the rotary position embedding to which the weight is applied according to an embodiment of the present disclosure is implemented as a linear product of the existing rotary position embedding result and the self-attention score, thereby efficiently extending the context window without an overhead of an additional computation.

Various embodiments and the effects thereof according to the present disclosure have been mentioned with reference to FIGS. 1 through 8. The effects according to the technical spirit of the present disclosure are not limited to those mentioned above, and other effects not mentioned will be clearly understood by one of ordinary skill in the art from the description below.

While all components comprising the embodiments of the present disclosure have been described as being combined or operating in conjunction, it should not be understood that the present disclosure is limited to such embodiments. That is, within the scope of the objectives of the present disclosure, all such components can selectively be combined and operate in one or more configurations.

Although operations are illustrated in a specific order in the drawings, it should not be understood that the operations must be performed in that specific order or sequentially, or that all the illustrated operations are required to achieve desired results. In certain circumstances, multitasking and parallel processing may be advantageous. Furthermore, the separation of various components in the described embodiments should not be understood as necessary, and the described program components and systems can generally be integrated into a single software product or packaged into multiple software products.

While the embodiments of the present disclosure have been described with reference to the attached drawings, it will be understood by one skilled in the art that the present disclosure can be implemented in other specific forms without departing from the technical spirit or essential characteristics thereof. Therefore, the described embodiments should be considered in all respects as illustrative and not restrictive. The scope of the present disclosure is to be interpreted by the following claims, and all technical spirits within the equivalent scope are to be interpreted as included within the rights of the present disclosure.

What is claimed is:

1. A method for extending a context window, the method being performed by a computing device, the method comprising:
performing a rotary position embedding computation on a first embedding vector and a second embedding vector input to an artificial intelligence model to calculate a first position embedding and a second position embedding respectively corresponding to the first embedding vector and the second embedding vector;
calculating a self-attention score between the first embedding vector and the second embedding vector, based on the first position embedding and the second position embedding;
performing position interpolation on the self-attention score in order to extend a context window of the artificial intelligence model;
calculating a decay weight related to a relative position difference between the first embedding vector and the second embedding vector; and
applying the calculated decay weight to the self-attention score subjected to the position interpolation, thereby updating the self-attention score.

2. The method of claim 1, wherein the performing of the position interpolation includes:
determining, as a scaling factor, a ratio of a second length of a context window as an extension target length to a first length of a context window initially preset on the artificial intelligence model; and
scaling the relative position difference by the scaling factor.

3. The method of claim 1, wherein the performing of the position interpolation includes:
obtaining a rotation matrix corresponding to the self-attention score; and
scaling a rotation angle of the rotation matrix by a preset scaling factor.

4. The method of claim 1, wherein the decay weight is exponentially decreased as the relative position difference increases.

5. The method of claim 1, wherein a hyperparameter of the decay weight is determined such that a first amplitude of the self-attention score based on the relative position difference after the decay weight has been applied is reduced relative to a second amplitude of the self-attention score based on the relative position difference before the decay weight is applied by a preset target ratio.

6. The method of claim 5, wherein the preset target ratio is determined based on at least one of a length of a prompt input to the artificial intelligence model, a length of a context window preset on the artificial intelligence model, a length of a context window as an extension target length on the artificial intelligence model, a performance of the artificial intelligence model, and a purpose of a task performed by the artificial intelligence model.

7. The method of claim 1, further comprising fine-tuning the artificial intelligence model using the updated self-attention score.

8. The method of claim 1, wherein the first embedding vector is a query vector, and the second embedding vector is a key vector.

9. A computing device comprising:
a processor; and
a memory for storing therein instructions,
wherein when the instructions are executed by the processor, the instructions cause the processor to:
perform a rotary position embedding computation on a first embedding vector and a second embedding vector input to an artificial intelligence model to calculate a first position embedding and a second position embedding respectively corresponding to the first embedding vector and the second embedding vector;
calculate a self-attention score between the first embedding vector and the second embedding vector, based on the first position embedding and the second position embedding;
perform position interpolation on the self-attention score in order to extend a context window of the artificial intelligence model;
calculate a decay weight related to a relative position difference between the first embedding vector and the second embedding vector; and
apply the calculated decay weight to the self-attention score subjected to the position interpolation, thereby updating the self-attention score.

10. The computing device of claim 9, wherein the performing of the position interpolation includes:
determining, as a scaling factor, a ratio of a second length of a context window as an extension target length to a first length of a context window initially preset on the artificial intelligence model; and
scaling the relative position difference by the scaling factor.

11. The computing device of claim 9, wherein the performing of the position interpolation includes:
obtaining a rotation matrix corresponding to the self-attention score; and
scaling a rotation angle of the rotation matrix by a preset scaling factor.

12. The computing device of claim 9, wherein the decay weight is exponentially decreased as the relative position difference increases.

13. The computing device of claim 9, wherein a hyperparameter of the decay weight is determined such that a first amplitude of the self-attention score based on the relative position difference after the decay weight has been applied is reduced relative to a second amplitude of the self-attention score based on the relative position difference before the decay weight is applied by a preset target ratio.

14. The computing device of claim 13, wherein the preset target ratio is determined based on at least one of a length of a prompt input to the artificial intelligence model, a length of a context window preset on the artificial intelligence model, a length of a context window as an extension target length on the artificial intelligence model, a performance of the artificial intelligence model, and a purpose of a task performed by the artificial intelligence model.

15. The computing device of claim 9, wherein when the instructions are executed by the processor, the instructions further cause the processor to fine-tune the artificial intelligence model using the updated self-attention score.

16. A non-transitory computer-readable recording medium storing computer program, wherein the computer program is connected to a computing device, and is configured to, when executed by the computing device, cause the computing device to:
perform a rotary position embedding computation on a first embedding vector and a second embedding vector input to an artificial intelligence model to calculate a first position embedding and a second position embedding respectively corresponding to the first embedding vector and the second embedding vector;
calculate a self-attention score between the first embedding vector and the second embedding vector, based on the first position embedding and the second position embedding;
perform position interpolation on the self-attention score in order to extend a context window of the artificial intelligence model;
calculate a decay weight related to a relative position difference between the first embedding vector and the second embedding vector; and
apply the calculated decay weight to the self-attention score subjected to the position interpolation, thereby updating the self-attention score.

17. The non-transitory computer-readable recording medium of claim 16, wherein the performing of the position interpolation includes:
determining, as a scaling factor, a ratio of a second length of a context window as an extension target length to a first length of a context window initially preset on the artificial intelligence model; and
scaling the relative position difference by the scaling factor.

18. The non-transitory computer-readable recording medium of claim 16, wherein the performing of the position interpolation includes:
obtaining a rotation matrix corresponding to the self-attention score; and
scaling a rotation angle of the rotation matrix by a preset scaling factor.

19. The non-transitory computer-readable recording medium of claim 16, wherein the decay weight is exponentially decreased as the relative position difference increases.

20. The non-transitory computer-readable recording medium of claim 16, wherein a hyperparameter of the decay weight is determined such that a first amplitude of the self-attention score based on the relative position difference after the decay weight has been applied is reduced relative to a second amplitude of the self-attention score based on the relative position difference before the decay weight is applied by a preset target ratio.
